(19) United States
(12) Patent Application Publication
(10) Pub. No.: US 2017/0308674 A1
(43) Pub. Date: Oct. 26, 2017

(54) SYSTEM AND METHOD FOR THE GENERATION AND TRANSFER OF A CONTINGENTLY DELIVERABLE PROPERTY RIGHT

(71) Applicants: Stephen Jeffrey Salzer, Greenwich, CT (US); Samir Varma, Cos Cob, CT (US)

(72) Inventors: Stephen Jeffrey Salzer, Greenwich, CT (US); Samir Varma, Cos Cob, CT (US)

(21) Appl. No.: 15/493,110

(22) Filed: Apr. 20, 2017

Related U.S. Application Data
(60) Provisional application No. 62/325,420, filed on Apr. 20, 2016.

(51) Int. Cl. G06F 19/00

(52) U.S. Cl. CPC G06F 19/3456; G06F 19/328

(57) ABSTRACT

System and methods are described herein for generating and transferring a contingently deliverable property right (CDPR) associated with a medical good or service. Ownership of the CDPR may be separated from delivery of the medical good or service. In one aspect, a method may include generating a CDPR unique ID for a medical good or service made available by a medical provider and storing the CDPR unique ID and medical good or service information in an object in the memory. The method may further include receiving first ownership information corresponding to the medical good or service, and associating the first ownership information with the CDPR unique ID. The CDPR unique ID may indicate or include a transferrable right to take delivery of the medical good or service.

### PRIORITY CLAIM

This application claims the benefit of U.S. Provisional Patent Application Ser. No. 62/325,420 filed Apr. 20, 2016, the contents of which are incorporated by reference in their entirety as if fully set forth herein.

### FIELD OF THE INVENTION

The present disclosure is directed to associating a contingently deliverable property right to a medical good or service with ownership that is decoupled from delivery, thus enabling transfers of the property right unrestricted by delivery constraints.

### BACKGROUND OF THE INVENTION

Currently, a patient or consumer may obtain certain medical goods or services, such as prescription drugs, an x-ray or CAT scan, medical examination, and so on, only after obtaining a prescription from a qualified medical provider. In some cases, for insurance coverage to apply, the good or service must be pre-approved by an insurance company or utilization reviewing entity associated with an insurance company. Once the prescription is issued, the patient may then obtain the good or service, sometimes restricted by which provider to choose from by the insurance company or utilization reviewing entity. Once the good or service has been contracted for, the patient is locked into paying a certain amount and receiving the good or service according to the prescription. In other cases, where a prescription is not needed, the insurance company or utilization reviewing entity may nonetheless place certain restrictions on obtaining medical goods or services that qualify for beneficial insurance treatment.

In both of these cases above, the transferability of the right to the good or service is restricted. In some cases, due to these and other restrictions on contracting for medical goods and services, resources may go underutilized. This may include x-ray or MRI machines going unused for periods of time that may set the medical provider back significantly, for example, due to the high initial cost of such machines.

Some utilization review companies are attempting to redirect the purchase of goods and/or services to lower-cost providers. Bulk purchasers, such as insurance companies, hospitals, pharmacy benefit managers, and the like, use their market clout to get better prices. Each current approach requires individual contracts and negotiations between the various entities. However, these deals do not effectively manage the supply and demand for medical goods and services. There is no central interface for buyers and sellers of medical services to get together (along with potential liquidity providers) to allow the market to clear.

### BRIEF DESCRIPTION OF THE DRAWINGS

Preferred and alternative examples of the present invention are described in detail below with reference to the following drawings:

FIG. 1 is a computer network or similar digital processing environment in which a contingently deliverable property right may be created and transferred according to an exemplary embodiment;

FIG. 2 is a block diagram of the internal structure of a computer or device operable in the computer network of FIG. 1;

FIG. 3 is an application layer diagram of a contingently deliverable property right platform operable in the computer network of FIG. 1;

FIG. 4 is a block diagram of a contingently deliverable property right utilized by the application layer diagram of FIG. 3;

FIGS. 5-12 illustrate flow charts of an example process for transferring a contingently deliverable property, which may be implemented by the contingently deliverable property right platform of FIG. 3;

FIGS. 13-20 illustrate example user interfaces that may be provided by the platform of FIG. 3;

FIG. 21 illustrates a flow diagram of an example processes that may be performed by the platform of FIG. 3.

### DETAILED DESCRIPTION OF THE PREFERRED EMBODIMENT

Systems and methods are described for creating a contingently deliverable property right (CDPR) to a medical good and/or service where no such property right currently exists. A CDPR, which will be described in more detail below, is associated the right to freely transfer the medical good or service and enables the creation of an exchange system or platform where qualified providers can transfer medial goods and services to a consumer or buyer without the requirement that ownership necessitate delivery of the good or service. The described systems and methods may address one or more of current supply and demand problems, liquidity problems, and other problems identified above.

In one aspect, a CDPR may be associated with a right to get a specific good and/or service at a specific price, with other optional restrictions specified by the provider, such as (but not limited to) a specific time(s) and/or place(s) at which a service is to be used. Each CDPR is fungible and can be transferred (e.g., bought and/or sold). In one aspect, a CDPR would be created at the moment that a provider offered a good and/or service at a certain price (with or without other restrictions) and that particular offer was bought or otherwise agreed upon by another party, whether or not that other party was the final user. The CDPR, which is exemplified by a data structure, array, or object, contains goods/services information, ownership information, and any restrictions on the delivery of the good or service. A CDPR platform, to be described in more detail below, is provided to interface with existing medical systems, to enable the creation and storage of CDPR objects, and the transfer of such rights through various user interfaces.

In one aspect, the utilization of CDPRs enables a new way to exchange and transfer medical goods and services, for example, via a platform or system described in more detail below. The platform or system may provide or create a new marketplace that does not currently exist. This marketplace enables patients, insurance companies, medical goods and/or services providers, and potentially other parties to all mutually benefit, by further enabling currently unused and/or underused medical goods and/or services to be monetized, which further optimizes the market.

The good and/or service could be bought before it was used, in which case the right would be transferable from the buyer to anyone else and would not be refundable: the provider would be paid regardless of whether it was used or not. Alternatively, the good and/or service right may simply be contracted for (for example, via a utilization review process) in which case it would be similar to a non-recourse booking, where the price is guaranteed under the conditions set by the provider, but if the good and/or service is unused, no payment is made. The provider could also set other conditions if it so desired, including (but not limited to): prepayment discounts, non-transferability of appointment, no-show charges, and the like. In yet another aspect, the provider could offer different prices for fully and/or partially refundable goods and/or services versus non-refundable goods and/or services.

In one aspect, liquidity allows non users to transfer (e.g., buy and sell) ownership of medical goods and services, with the right to delivery of the medical good or service contingent upon verification of need or prescription of the medical good or service.

In another aspect, the described systems and methods may enable the monetization of previously unused and/or underused medical goods and/or services.

In one aspect, the described systems and methods may be inserted into and interface with the utilization review process, for example, to provide for better pricing, more supply, and/or incentives to the buyer or end consumer.

In another aspect, key point(s) of economic leverage are identified which allow for insertion of and integration of the described systems and methods at the proper point in the medical review system to add efficiency to existing processes.

The current market for medical purchases (services and/or goods) does not work well, particularly for routine medical goods and services. One of the major reasons for this is that transactions are not priced dynamically: that is, they are not priced according to supply and demand. There are numerous reasons for this. Among these are history, complexity, difficulty of changing workflows, regulations, lack of clarity about processes, the difficulty with burdening busy medical professionals with still more mandates, and so on. The various players have radically different interests, have great difficulty cooperating for the common good, and have no sensible way in which to share economic gains that would accrue from more rational business practices.

Many medical service providers, such as, for example, radiology practices, have significant times of the day or week in which they are not busy. It would be to their benefit, and to the benefit of all the other stakeholders, if there was some way in which those service providers were able to dynamically price their services so they were able to “fill up” their less busy times. For example, in one aspect of the present disclosure, an MRI machine costs approximately $1,500,000. Every minute the machine sits unused is a significant loss to the owner and/or operator. In one example, the times when the machine sits unused can be discounted, creating a huge benefit to the owner of the machine, as well to the insurance company and/or patient paying the bill. However, any innovation that significantly changes the workflows of the doctor, radiologist, insurance company or utilization reviewer is highly unlikely to ever be adopted, regardless of its potential benefits. Other potential sellers, for example, a manufacturer of pharmaceuticals, may temporarily find itself with excess production capacity but has no mechanism to signal the market of its willingness to lower prices to utilize this capacity.

In one example of current systems, a patient goes to see a doctor who orders a set of tests, prescribes drugs and orders a piece of medical equipment (perhaps a wheelchair or a CPAP machine). The doctor decides the patient needs an MRI (this example illustrates procurement of an MRI, although parallel examples could be constructed for any other diagnostic tests, drugs, or types of medical equipment). The doctor or his staff then call the patient's insurance company and speak with its utilization reviewers, who determine the medical necessity of the MRI. The utilization review team issues an authorization code. The doctor's staff then typically calls a radiology provider that offers the MM, gives them the authorization code, while simultaneously directing the patient to the facility. The radiology provider then performs the MM and reads the scan, and submits the claim to the insurance company along with the authorization code. The insurance company processes the claim and pays the radiology provider according to its contract with the radiology provider, if in the patient's health insurance network, or “reasonable and customary charges” (which can lead to balance billing of the patient) if out of the patient's health insurance network.

To make the above-described process more efficient, CDPRs can be created, transferred, and tracked, so as to enable more liquidity in the providing of medical goods and services. The CPDR platform enables dynamic pricing of medical services with a minimum of disruption to the workflow of the doctors, insurance companies, regulators, service or product suppliers and/or utilization reviewers, while simultaneously providing benefits to the patient, doctor, insurance company, utilization reviewer and the service provider, as will be described in more detail below.

One aspect of the described systems and methods identifies the point or points at which dynamic pricing can be inserted into the workflows of the doctor, utilization reviewer, insurance company and product/service provider, such that the benefits are maximized with the minimum of disruption. One such maximal leverage point with minimal disruption is at the point of utilization review (typically a phone call or on-line process) initiated by the doctor's office to the utilization review company, when the doctor first orders a specific service as described above.

Another aspect provides a new marketplace where providers can offer their drugs, supplies, and professional services, including and particularly excess capacity, at a price and with conditions of their choosing. The CDPR platform enables patients to provide their own bids for goods and/or services, given relevant restrictions, such as, for example, but not limited to, the time of day the patient wants a service, with the providers matching and/or beating the bids. By allowing providers to place their asks, and patients to place bids, the marketplace facilitates commerce that would otherwise not occur and provides benefits to multiple parties.

In yet another aspect, for an insured patient, the maximal point of economic leverage is to insert the invention into the workflow at the point of utilization review. A market is set up where multiple good and/or service providers, such as, for example, radiologists, post their prices for various goods and/or services at various times. This feature of the CDPR platform is not necessarily open to the public or to patients, but optionally can be. When the doctor calls the utilization review company, the utilization reviewer would get, for example, a pop-up screen, either integrated into their own software, or via an external application or website, which would show, for example, a set of parameters, including, but not limited to: a range of providers with the lowest price for the service, within some defined area (for example, by zip code) and by availability. The utilization review company would communicate the possibility of a lower price to the doctor's office, who would let the patient know they had a choice: pay the standard fees which could include a co-pay, deductible and co-insurance, or, if they were willing to go to a particular facility at a particular time, they would get an incentive, such as reduced rates. This communication could also be handled by other means, such as to a mobile device, via text message, email, website, phone call, and the like, as will be described in more detail below. The incentive to the patient to accept the lower price could be one or more of a multitude of options: the patient's copay could be waived or reduced and/or a direct payment of some of the savings could be made to the patient whether in cash, a credit to a healthcare savings account, gift card, credit on an existing bill, or the like. The patient could also be given a range of choices, including, but not limited to, for example: go to this provider at price X, or that provider at price Y, or that one at price Z.

As an incentive to the doctor/medical provider to communicate the savings offer to the patient, the doctor could be given a cash payment, or extra points on their quality of service score as part of a pay-for-performance program or shared savings program or pay-for-quality program, a higher reimbursement rate on their billing code, preferential listing in a provider network, extra dollars per member per month, or any other incentive deemed worthwhile to the doctor. The insurance company's incentive would be to provide the same good or service at a lower price to its insured, and the incentive to the utilization reviewer would be either a portion of the savings, a direct payment from the user of this patent, and/or simply better service to its true customer—the insurance company, or another form of mutually-agreeable incentive.

In yet another aspect, carve-outs for specific types of goods and/or services are provided that are not amenable to a market based purchase. These could include, but are not limited to: in-patient services such as in-patient radiology, and in-house services such as in-house radiology or goods such as drugs administered while at a facility.

In another aspect, typically (but not necessarily) for uninsured/underinsured patients (where there is no utilization review), the patient may access a website, a kiosk, or various types of mobile applications, search for the good and/or procedure they need (via a procedure code and/or plain text, and/or any other indication of the good or procedure needed) and be given a list of choices from which to pick the lowest cost. The website/mobile application may receive a list of prices and times from the providers, and provide a list ranked by whatever attributes the user wanted: distance, price, time of day, time to delivery etc.

In another aspect, the patient may pre-pay via any means such as a credit card, payment service, wire transfer, and the like, for CDPRs for the goods or services purchased through the CDPR platform. This would obviate one of the biggest banes of medicine: the cost and distraction of chasing down individual payers for their medical payments. Pre-payment could optionally bring an additional discount.

In another aspect typically (but not necessarily) for uninsured/underinsured patients (where there is no utilization review), the patient may specify a price that they are willing to pay with flexibility on times, and put in their bid price for providers to match and/or beat. In another aspect, typically (but not necessarily) for uninsured/underinsured patients (where there is no utilization review), the patient may specify specific time(s) that they were available for a service or time by which they want a good delivered and ask for the best price based on those times. In another example, typically (but not necessarily) for uninsured/underinsured patients (where there is no utilization review), the patient may indicate various combinations of prices and times that they would find acceptable and submit the information through the CDPR platform. Providers in the platform may receive the request for services, and provide bids for providing the requested goods or services at or below the specified price and at the indicated times.

In another aspect of the CDPR platform, the provider of the service, may charge for its services on a per transaction basis, charge for its services in terms of a flat fee to the insurance company per user per month, charge fees as a percentage of the savings realized by the insurance company by using this service, or via a hybrid model containing these and other payment schemes.

In still another aspect of the CDPR platform, the insurance company may share its confidential pricing data with the marketplace service provider. The marketplace service provider can then use that data to calculate the savings that the insurance company was realizing and could thereby charge a fee based on those savings.

In another aspect of the CDPR platform, the marketplace service provider may provide its technology exclusively to one utilization review company, which would then be able to offer an exclusive value added service as compared to its competitors.

In one aspect, the marketplace service provider may contract with multiple utilization review companies to offer this service. In some cases, the marketplace service provider may broker the purchase of CDPRs for services, and/or an option to purchase CDPRs for services, in advance of when they are needed. In another aspect, the marketplace service provider may itself purchase or sell CDPRs for services, and/or the option to purchase or sell CDPRs for services, on its own account.

In another example, the marketplace service provider may act as a counterparty for others who desire to purchase or sell CDPRs for services in advance, or who desire to purchase the option to purchase or sell CDPRs for services.

In another aspect, the CDPR platform may keep track of and compile information relating to goods and services, and the transfer thereof. The marketplace service provider may sell data including, but not limited to, data on pricing, utilization, seasonality, and geographic distribution of goods and/or services used and/or options bought and sold; either as raw data or aggregated data and/or an analysis of this data.

In another example, the marketplace service provider may allow market makers to buy and sell services on the market. This would facilitate liquidity in the market, as well as provide guaranteed funding to the service provider.

In another example, the marketplace service provider could allow third parties to buy and sell services on the market. This would facilitate liquidity in the market, as well as provide guaranteed funding to the service provider.

In some aspects, the described techniques and systems may be applied to associate a contingently deliverable property right with other types of goods or services, for example, where the separation of ownership and a contingent right to delivery may provide benefits. For example, the described techniques and systems may be tailored for chemical compounds, such as uranium or other potentially dangerous materials. In this example, the right to ownership, which includes contingent rights of delivery, of the material may enable the creation of a more fluid market and platform to transfer the materials, without limiting the parties to the transaction to those who have proper facilities and rights to physical possess such materials. In another example, the described systems and techniques may be applied to weapons. In yet another example, the described techniques and systems may be modified to accommodate the transaction of restricted technology, for example, that is associated with complicated import and export licenses or controls.

Broadly, this disclosure is directed towards improved systems, methods, and/or apparatuses for providing a CDPR platform that generates rights to medical goods and services captured by a data structure, and enables the transfer of the rights in a way that separates ownership from delivery of the good or service. The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments or aspects may be combined in other embodiments.

Certain aspects of the CDPR system or platform and methods are described with reference to methods, apparatus (systems), and computer program products that can be implemented by computer program instructions. These computer program instructions can be provided to a processor of a general purpose computer, special purpose computer, mobile computing device, or other programmable data processing apparatus to produce a machine, such that the instructions, which execute via the processor of the computer or other programmable data processing apparatus, create means for implementing the acts specified herein to transform data from a first state to a second state.

These computer program instructions can be stored in a computer-readable memory that can direct a computer or other programmable data processing apparatus to operate in a particular manner, such that the instructions stored in the computer-readable memory produce an article of manufacture including instruction means which implement the acts specified herein. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified herein.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices such as, for example, a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a computer terminal. In the alternative, the processor and the storage medium can reside as discrete components in a computer terminal.

Certain acts, events, or functions of any of the methods described herein can be performed in a different sequence, can be added, merged, or left out altogether (e.g., not all described acts or events are necessary for the practice of the method). Moreover, in certain aspects, acts or events can be performed concurrently such as, for example, through multi-threaded processing, interrupt processing, or multiple processors or processor cores, rather than sequentially. Moreover, in certain embodiments, acts or events can be performed on alternate tiers within the architecture.

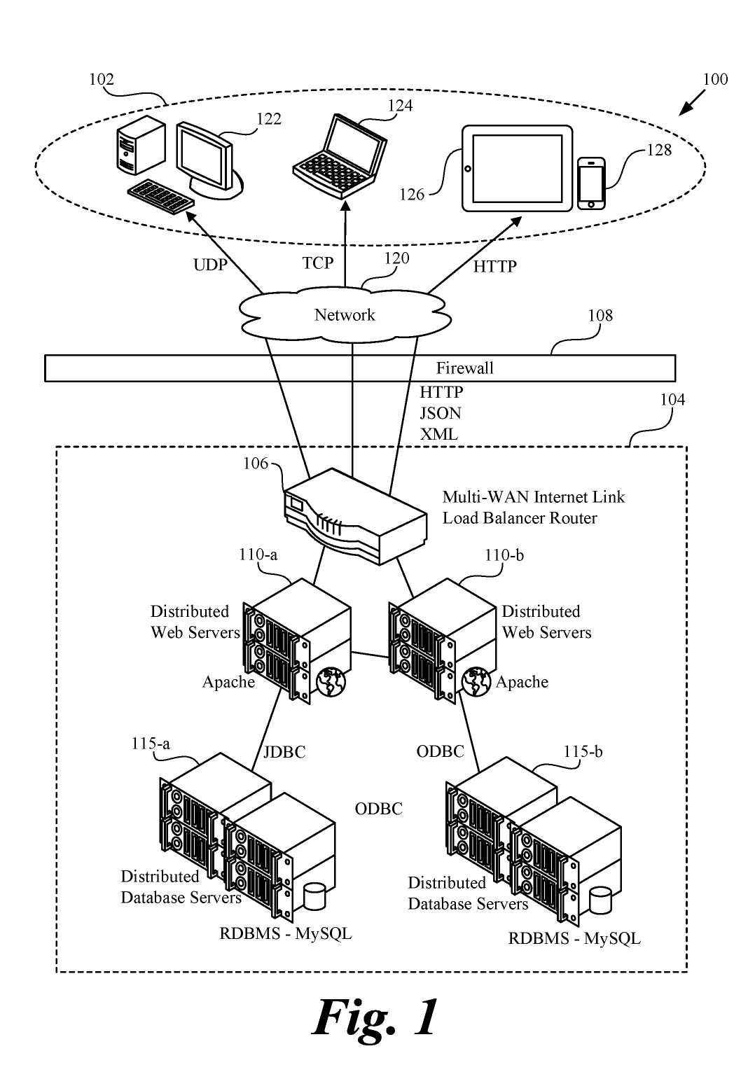

With reference now to FIG. 1, a computer network or similar digital processing environment 100 in which the system and method disclosed can be implemented. The present systems and methods can also run on different architectures that include a LAN, WAN, stand-alone PC, stand-alone mobile device, a stand-alone, clustered, or networked mini or mainframe computers, etc. The CDPR system and method of use can be distributed on multiple computers and devices 102, 104.

FIG. 1 is representative of many specific computing arrangements that can support the system and method disclosed. In one embodiment, the software implementing the promotion system runs in the Linux® environment. In another embodiment, the software is implemented to run in other environments, such as Windows®, UNIX®, and to run on any hardware having enough power to support timely operation of software such as that identified in FIG. 1. In some aspects, computers are deployed as virtual instances rather than physical computers.

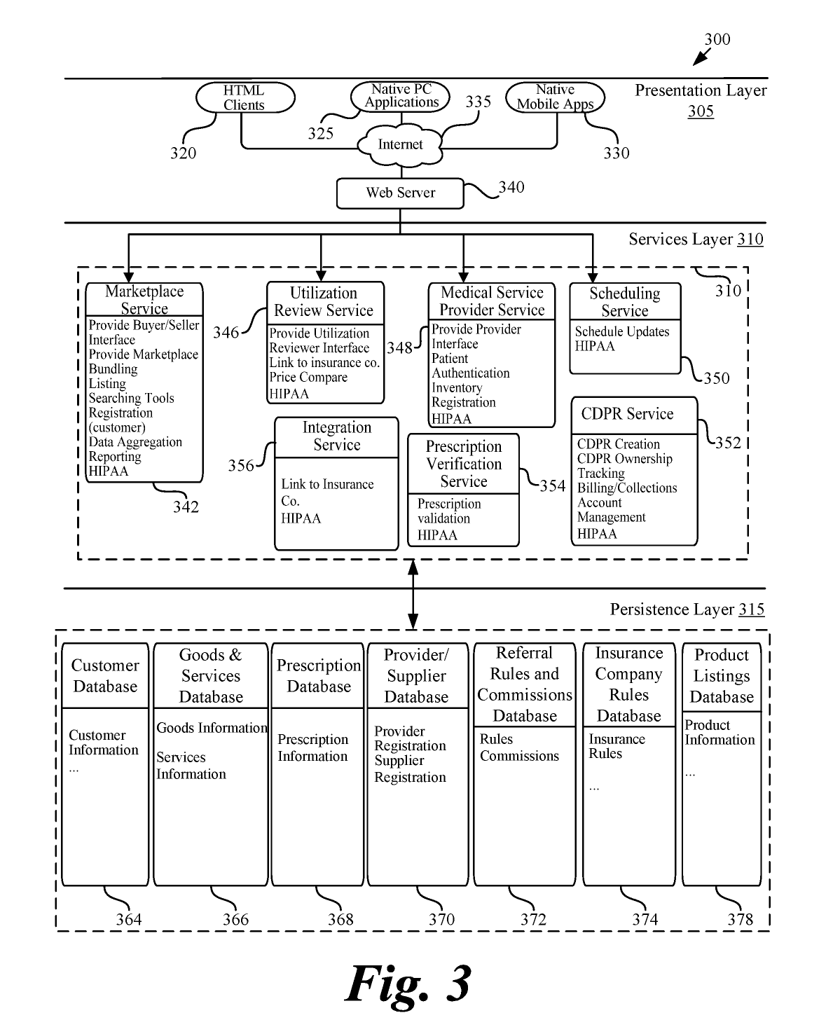

A load balancing router 106, such as for example a Multi Wan Router, can distribute traffic inside a firewall 108 to and from distributed web servers 110-a, 110-b. In some deployments, these webservers 110-a, 110-b are distributed instances of an Apache web server with a distribution of PHP installed, an instance of Node.js installed, or both, along with supporting libraries such as those configured for communicating with persistent data stores. The distributed web servers 110-a, 110-b are communicatively coupled to computers 115-a, 115-b hosting one or more persistent data stores. The data stores 115-a, 115-b can be distributed relational databases such as, for example, MySQL® or SQL Server® storing primary and derivative data generated by various services described in reference to FIG. 3. In an example, a distributed web server 110 may communicate with a distributed database server 115 via Java Database Connectivity (JDBC), Open Database Connectivity (ODBC), or other database communication protocol supported by the data store. The distributed database servers 115-a and 115-b may also communicate with each other via ODBC or other database communication protocol. In addition, or alternatively, the distributed database servers 115 may host XML databases, object oriented databases, NoSQL database, and the like.

Client computers of various types 102 can connect to a remote server infrastructure 104 via a network 120 over one or more communication protocols. All computers can pass information as unstructured data, structured files, structured data streams such as, for example, XML, structured data objects such as, for example, JSON objects, and/or structured messages. Client computers 122, 124, 126, 128 may communicate over various protocols such as, for example, UDP, TCP/IP and/or HTTP. In some cases, one or more client computers 122, 124, 126, 128 may communicate via a wireless connection with the network 120.

In some aspects, the wireless connection between one or more client computers 102 and the network 120 may implement or be part of a system that implements CDMA, TDMA, FDMA, OFDMA, SC-FDMA, and/or other wireless communication technologies. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM□, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2).

Client computers and devices 122, 124, 126, 128 and server computers 104 provide processing, storage, and input/output devices executing application programs. Client computers 102 can also be linked through communications network 120 to other computing devices, including other client devices/processes 102 and server computers 104. In some embodiments, server computers 115-a, 115-b host and execute software implementing centralized persistent data storage and retrieval. The network 120 can be a local area network and/or a wide area network that is part of a remote access network, a global network (e.g., the Internet), a worldwide collection of computers, and/or gateways that currently use respective protocols (TCP/IP, UDP, etc.) to communicate with one another. Multiple client computer devices 102 may each execute and operate instances of the applications accessing the CDPR platform or system.

On reading this disclosure, those of skill in the art will recognize that many of the components discussed as separate units may be combined into one unit and an individual unit may be split into several different units. Further, the various functions could be contained in one computer or distributed over several networked computers and/or devices, or instantiations of virtualized machines. The identified components may be upgraded and replaced as associated technology improves and advances are made in computing technology.

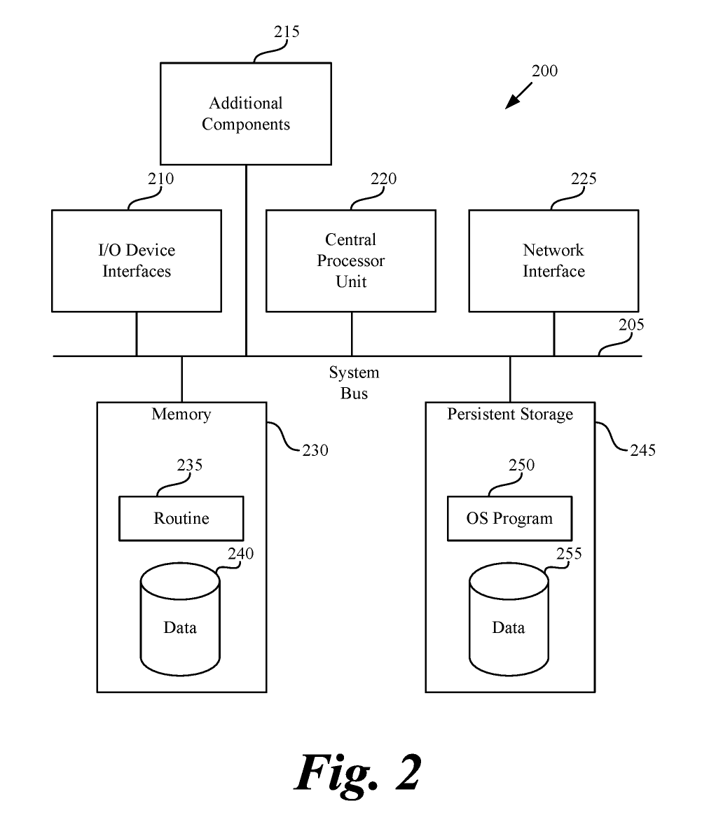

With reference to FIG. 2, each component of the system 200 is connected to a system bus 205, providing a set of hardware lines used for data transfer among the components of a computer or processing system. Also connected to the bus 205 are additional components 210 of the promotion platform system, such as additional memory storage, digital processors, network adapters, and I/O devices. The bus 205 is essentially a shared conduit connecting different elements of a computer system (e.g., processor, disk storage, memory, input/output ports, network ports, etc.) and enabling transfer of information between the elements. An I/O device interface 215 is attached to system bus 205 in order to connect various input and output devices (e.g., keyboard, mouse, touch-screens, displays, printers, speakers, etc.) to the CDPR system. A network interface 225 allows the computer to connect to various other devices attached to a network (e.g., network 120 of FIG. 1). A memory 230 provides volatile storage for computer software instructions 235 and data 240 used to implement methods employed by the system disclosed herein. Disk or persistent storage 245 provides non-volatile storage for computer software instructions 250 and data 255 used to implement an embodiment of the present disclosure. A central processor unit 220 is also attached to system bus 205 and provides for the execution of computer instructions.

In one embodiment, the processor routines 235 and 250 are a computer program product, including a computer readable medium (e.g., a removable storage medium such as one or more flash drives, DVDROM's, CD-ROM's, diskettes, tapes, etc.) that provides at least a portion of the software instructions for the system. A computer program product that combines routines 235 and data 240 may be installed by any suitable software installation procedure, as is well known in the art. In another embodiment, at least a portion of the software instructions may also be downloaded over a cable, communication, and/or wireless connection.

With reference now to FIG. 3, client devices, such as client devices 122, 124, 126, 128 of FIG. 1, can provide user interfaces via a presentation layer 305 to the functions of the CDPR system services layer 310. Such interfaces can be browser-based, application-based, or both. In some embodiments, these applications can include application containers such as html clients 320, native PC applications 325, and/or native mobile apps 330. Application containers 320, 325, 330 can interface with the CDPR services layer 310 via the internet 335, for example, through a web server 340. In some embodiments, client devices 122, 124, 126, 128 execute one or more applications that receive html pages generated by a web server 340. In some implementations, the web server 340 page generation and transmission is supported, at least in part, by a content management system.

The CDPR system architecture 300 can include a services layer 310 that exposes a variety of discreet services accessible to authorized clients or users 320, 325, 330. It is through these services that information can be added to, and retrieved from, the databases found in the persistence layer 315. The services layer 310, together with the persistence layer 315, can, in part, consist of a collection of tables and data stores supporting the CDPR system services. In some instances, services are implemented using server-side PHP code, and JavaScript code, implemented in conjunction with a content management system.

It should be appreciated that each service of services layer 310, and each database in persistence layer 315 may be configured to be compliant with current and new developments in HIPAA regulations.

In some embodiments, a CDPR service 352 provides associated methods and data structures for creating, maintaining, and updating CDPRs, including maintaining records of ownership of CDPRs. These functionalities are supported by data and data relations stored in the customer database 364 and the goods and services database 366, and/or the product listings database 378.

In some aspects, the CDPR service 352 may provide functions to create/update/track Unique IDs, which are herein referred to as CDPR unique IDs. Each good and service made available by a medical service provider, which may be stored in the goods and services database 366 may be associated with a CDPR unique ID. Upon transfer of ownership of a CDPR, the CDPR may then be associated with or linked to a customer via customer information (e.g., identified by a customer ID) stored in the customer database 364. In some cases, a history of the full ownership record/past transactions of a given CDPR may be stored or linked to the particular good or service, for example, in the goods and services database 366.

In some aspects, CDPR service 352 may also associate billing and collections information for a given CDPR with the CDPR unique ID and customer information, for example in the customer database 364. The CDPR service 352 may also provide user account management functions, such as establishing and maintaining passwords, payment, balances, addresses, credit cards, etc. In some cases, user account management functions may be provided by marketplace service 342.

In some cases the CDPR service 352 may provide functions to print appointment confirmations optionally with a unique authentication code, time of appointment, date of appointment, address, terms, provider, warning that the appointment has been bought and is nonrefundable, and so on.

The CDPR service 352 may interact with the marketplace service 342 and other services to provide the various features of system 300, described throughout this disclosure.

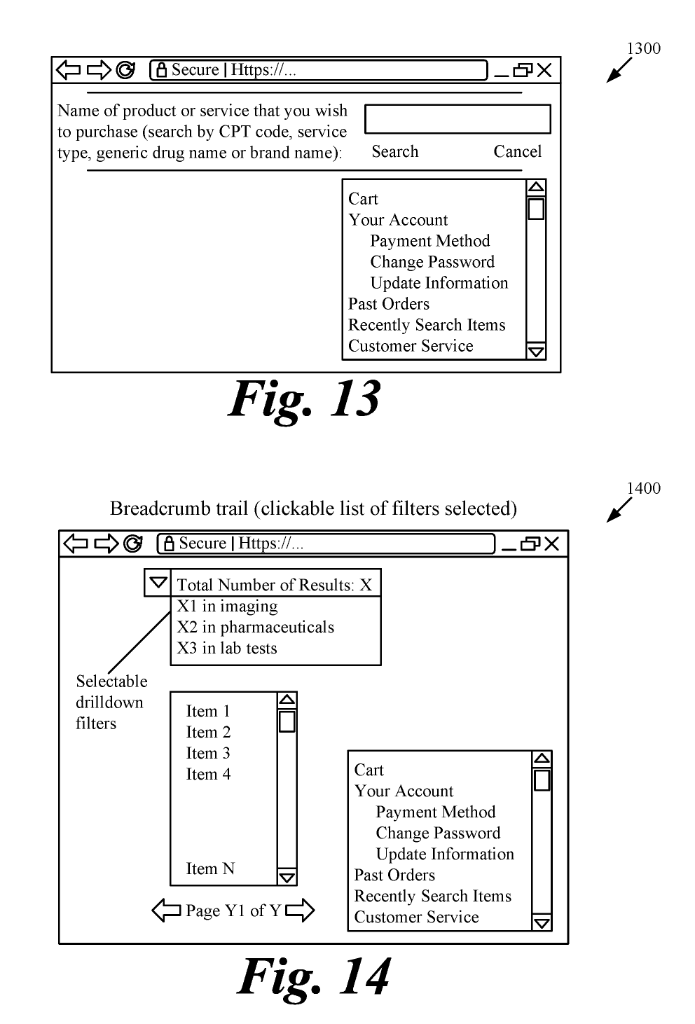

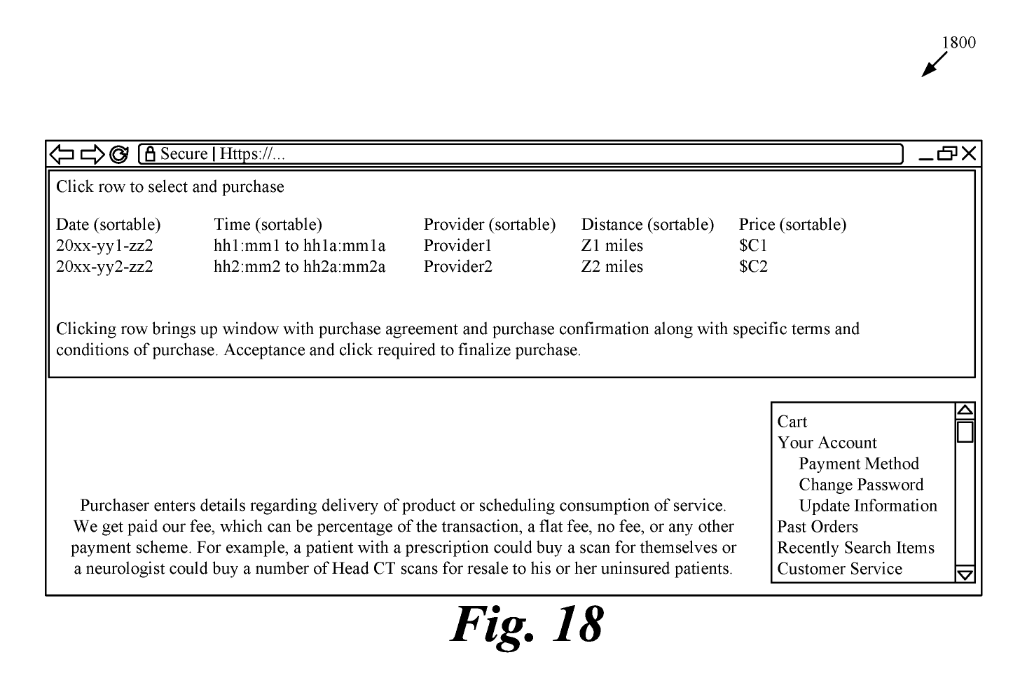

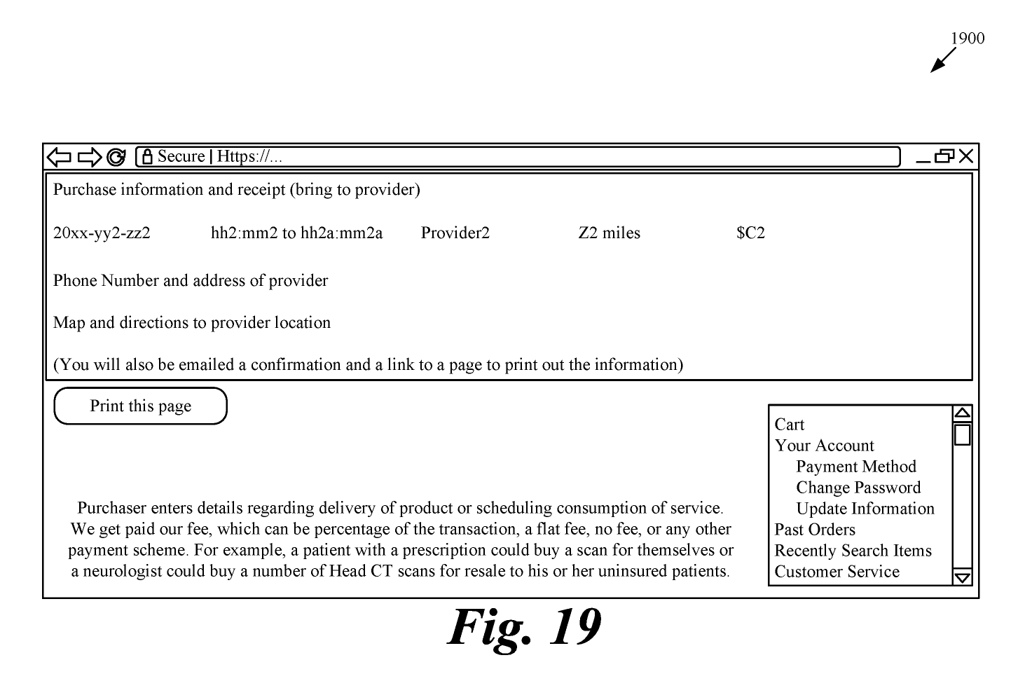

In some embodiments, a marketplace service 342 provides associated methods and data structures for user access and management functionality, listing of CDPRs, and transactions and transfers of CDPRs, including providing one or more user interfaces (UIs) for buying and selling CDPRs. Example screens of a transactional UI are illustrated in FIGS. 13-20, which will be described in greater detail below. These UI displays provide example selections for buying and selling medical goods and services tracked or accounted for via CDPR unique IDs. The functionalities provided by the marketplace service 342 may be supported by data and data relations stored in the customer database 364, goods and services database 366, prescription database 368, provider/supplier database 370, referral rules and commissions database 372, insurance company rules database 374, and product listing database 378.

In some instances, the marketplace service 342 implements an authentication-based roles and privileges model limiting access to the CDPR system, limiting system functionality based, at least in part, on assigned roles, assigned privileges, or both. These assigned roles may include a medical services provider, a utilization reviewer, and end consumer, a third party, etc.

In some aspects, the marketplace service 342 may provide a UI or specific selection items in a UI/API, for bulk purchasers, to show current holdings & functions to allow bulk changes, such as sales, purchases, etc. This interface may provide selections and options for bundling and unbundling of medical goods and services. In some aspects, marketplace service 342 may provide a set of functions/APIs to enable buyers to bundle and unbundle groups of medical goods and services.

In some cases, marketplace service 342 may enable the bundling of different but similar drugs/devices (e.g. Nasonex® and Flonase®), so that a user can bid for either so that they trade as a single commodity and compete with each other. Marketplace service 342 may provide functions to create alternative bundles where the content of the bundle is specified functionally. For example, if the bundle is of NSAIDs, the bundle could contain any combination of Advil®, Aleve®, Motrin® and aspirin, but the exact mix would be unknown to the buyer. Bundle could be standardized via it being an N-day supply at the standard dosing level. In some aspects, the marketplace service 342 may include functions to create standardized bundles based on certain criteria.

In some aspects identification information (e.g., a bar code) may be applied to or associated with a CDPRs for a bundle of goods or services. For example, an entity purchases a CDPR for 100 boxes of pills. The CDPR for 100 boxes would be associated with a first bar code. The CDPR for the group of 100 boxes may be split into groups of 75 boxes and 25 boxes, for example, to resell to two different parties. The original bar code would be invalidated, and two new ones are issued: one or a CDPR for the 75 and one for a CDPR for the 25.

The marketplace service 342 may provide listing functions to allow bulk listing & delisting for providers and investors, including mechanisms to delist goods or services. The listing functions may also include dynamic listing functions, such that prices of a listing may be automatically adjusted in relation to the time the listing is active (e.g., list this service at $110, but adjust price to keep me lowest cost, but don't go lower than $90). Dynamic listing functions may also include listing with a reserve price, such that a listing is always the lowest cost amongst these competitors, but no lower than a set limit. The listing functions may also include reverse auction functions, such that a patient or bulk purchaser may provide their criteria and providers can bid to supply that demand. For example, a user may indicate that they desire to contract to buy CDPRs for 200,000 CAT scans in 2018. This information may be made available to enable providers to bid on providing the requested number of CDPRs for CAT scans.

In some cases, each listing may be stored in the listings database 378 when made available for transfer. In some aspects, each good or service has the option to list specific time slots for sale. Other listing options may include a specific facility, different pricing for the same service at different times or locations or discounts for purchases made far in advance. Other listing options may be available to providers and vendors, such as always listing the good or service at the lowest price in a given category, but no lower than a given (set) amount.

In some examples, the marketplace service may provide functions to enable a third party to trade on its own account, for example, to act as a counterparty, etc. The third party (e.g., provider of system 300) may buy and sell on its own marketplace. This may both facilitate liquidity and be a potential profit source. In one example, a third party may guarantee transactions of CDPRs, similar in kind to the way a futures exchange works. For example, if a seller goes bankrupt or is unable to provide the good or service, the third party may guarantee the delivery, for example in return for compensation. The marketplace service 342, in some examples, may provide two types of trades, where either parties contract directly with each other, or for an extra fee, a third party can guarantee the transaction by serving as the counter party to both sides.

In some cases, insurance companies may provide the third party confidential list of credentialed vendors and providers and the contracted fee schedule for each good or service. The third party may contract with those providers and vendors offering them the option to list with the third party a price for each good or service. In some cases the insurance company may change the goods and services listed through the marketplace service 342, but are contractually obligated to provide the goods and services at the price they listed at the time of sale. In some cases, functionality may be provided for the third party to select which vendors it contracts with, for example, using algorithms that select vendors/providers that offer the lowest price, and/or meet other criteria.

The marketplace service 342 may also provide, for example via one or more UIs, search functionality to enable searching for CDPRs to purchase or sell (e.g., functions to find the lowest cost provider, or functions based on other constraints). The marketplace service 342 may provide algorithms that allow customers to indicate preferences such as closest distance, lowest price, closest available provider, soonest possible date, etc. Customers may indicate preferences via a UI, and those preferences can be stored (e.g. this customers always wants the closest not the cheapest). One or more search indices may be provided to support search functionality.

The marketplace service 342 may provide registration functionality to enable users to register with the service. This may include storing personal information and/or account information of the customer in the customer database 364.

In some aspects, the marketplace service 342 may provide reporting functionality that tracks and provides, via one or more UIs, gains/savings from using the system, including reports that show the geographical distribution of customers and savings. In some cases, transaction/sales data may be aggregated, analyzed (e.g., consumption, demand, seasonality, etc.), and, for example, sold to investors and/or insurance companies. Aggregated data may be useful for aiding investors to invest more profitably or insurance companies to buy more cheaply, and/or to track preferences of patients.

In some cases, marketplace service 342 may provide provider rating functionality, for example that may be useful to other consumers or to the medical providers.

In some embodiments, a utilization review service 346 provides associated methods and data structures for interfacing with utilization review organizations and systems functionality. These functionalities are supported by data and data relations stored in the goods and services database 366, the provider/supplier database 370, and/or the insurance company rules database 374/remote insurance company rules database 374-a.

In some cases, utilization review service 346 may provide one or more UIs to enable the utilization reviewer organization or system to realize benefits in selecting more available medical goods and services for insurance approval, for example, by interfacing with the marketplace service 342.

In some aspects, the utilization review service 346 may include functions that prompt the utilization reviewer or system/interface with the utilization reviewer organization or system to approve or deny coverage for a specific medical good or service. This may include prompting a dialogue or specific workflow, etc. with the reviewing system or organization.

In some aspects, the utilization review service 346 may provide functions needed to integrate with each medical review organization plus additional functions to integrate with their customers and suppliers. This may include: functions for comparing the best available price to the best contracted price available through the insurers contracts with providers and to then incentivize the selection of the lower price of the two. This may be absolute (offer only the lower priced provider) or relative (if this provider is chosen, then a reward is issued).

In some embodiments, a medical service provider service 348 provides associated methods and data structures for redeeming CDPRs for medical goods and services, registering medical service provides with system 300, and other functionality. In some aspects, the medical service provider service 348 may interface with the prescription verification service 354 to validate prescriptions for redemption of medical goods or services. These functionalities are supported by data and data relations stored in the provider/supplier database 370, prescription database 368, goods and services database 366, and one or more of the other databases in persistent layer 315.

In some cases, medical service provider service 348 may provide one or more UIs to enable the medical service provider to list medical goods or services in the system 300/via marketplace service 342, for example, at lower costs based on down time, lower demand at certain times of the day, etc. This feature of system 300 may provide additional benefits and increases in market fluidity.

In one aspect, medical service provider service 342 may provide interfaces (e.g., including a UI), and functions to enable redemption, consumption and/or delivery of medical goods and services. This may include functions to authenticate that the patient who shows up at appointment actually owns the rights to the medical good or service. In some cases, the medical service provider service 342 may generate a code or other unique identification information, such as a bar code, that is associated with the CDPR for the medical good or service (e.g., associated with the CDPR unique ID). This identification information may be provided to the owner/purchaser of the CDPR for the medical good or service upon purchase of the CDPR for medical good or service, for example through a mobile application. Each time a CDPR for a good or service is resold, the original bar code/identification information is canceled and a new one issued so that only the final issued bar code is valid. In one example, a unique code may be generated for each CDPR for a good/service, and changed each time the good/service gets sold. In another example, a field within the CDPR for the good or service (e.g., associated with the data structure defining the specific instance of the medical good or service) may simply be updated after every sale.

In some cases, the unique identification information may include or be derived from one or more pieces of information of a CDPR, such as the CDPR unique ID. In some cases, the CDPR service 352 and/or the marketplace service 342 may generate and/or associate the identification information with a CDRP, and communicate that information to the medical service provider service 348.

In one example, an individual shows up at a Doctor's office for a medical service, e.g., some type of diagnostic scan. To authenticate that an individual has the right to the good or service, the individual would pull up the bar code or other identification information on a mobile application, website etc., for example, to display to the medical service provider, to redeem the good or service. In other cases, validation may be performed through functions integrated into their medical service provider's management software.

The bar code/identification information will have no identifying patient related information. This ensures privacy and HIPAA compliance. In one aspect, the identification information may effectively be similar to a “bearer bond,” and for example, may be printed on paper.

In some cases, medical service provider service 342 may provide new provider registration functions, to enable registered providers to interface with the marketplace service 342 and other aspects of system 300. The medical service provider service 342 may also perform functions to credential providers, such as validating a certain level of insurance of the provider, validating which medical plans/insurance the provider accepts provider participates in a plan, etc. For standalone providers, more, and sometimes, custom measures may be taken to ensure a certain level of medical goods or services is provided by the provider.

Medical service provider service 342 may also provide functions to perform verification (e.g., periodic) of providers to ensure equality of service, licensing of the medical service provider, etc.

In some embodiments, a scheduling service 350 provides associated methods and data structures for scheduling functionality. These functionalities are supported by data and data relations stored in goods and services database 366, the provider/supplier database 370, and/or the product listings database 378.

The scheduling service may provide functions to interface with provider/manufacturer reservation, management, scheduling and/or inventory systems of the medical provider, for example, to block off times or time slots that correspond to CDPRs for medical goods or services that have been purchased. For example, when a time slot corresponding to a CDPR for a medical service gets purchased, the time slot will be updated in the provider's scheduling software to indicate that a service is to be performed at that time. In some cases, when a CDPR for a listed slot is purchased other than through the third party operating the system, the CDPR/time slot may be delisted in the product listings database 378.

In some embodiments, a prescription verification service 354 provides associated methods and data structures for verifying prescription functionality. These functionalities are supported by data and data relations stored in a prescription database 368 and a customer database 364.

The prescription service 354 may provide functions to capture/validate prescriptions optically, electronically, photo, scan, etc. The prescription verification service 354 may interface with the medical services provider service 348 and/or the marketplace service 342 to provide a UI to provide a request for prescription information, and selections to input prescription information to enable validation/authentication for delivery of a medical good or service.

In some embodiments, an integration service 356 provides associated methods and data structures for integrating with external systems functionality. These functionalities are supported by data and data relations stored in one or more databases of persistence layer 315.

The integration service 356 may link system 300 to various entities, such as linking to insurance companies, scheduling software, inventory software, etc. In some aspects of the system 300, different portions of the functionality of the services described above may be implemented in external systems. In these cases, the integration service 356 may provide necessary information to, and retrieve necessary information from, external services and databases.

In some embodiments, some or all of the services in the services layer 310 may communicate with each other to better facilitate data organization and transfer. Similarly, some or all of the databases in the persistence layer 315 may communicate with each other to better facilitate data organization and transfer.

In some aspects, one or more pieces of system 300 may be decentralized, in that various functionality may be performed by different computing machine, for example, at different locations. This may include portions or all of certain databases being provided by other systems, for example, external to system 300, but accessible by one or more services of layer 310. In one example, system 300 may interface with a utilization reviewer organization's own system or a medical service providers own system, to provide the functionality described above. For example, the scheduling service 350 may either be a system of the medical providers, such that system 300 may only send notifications to the scheduling service 350 to mark time slots associated with purchased CDPRs for medical services, and may not perform the actual task of scheduling the service as booked or taken. In other cases, the scheduling service 350 may interface with a medical provider's system and may provide a calendar for scheduling purchased CDPRs for medical services a booked.

In some cases, one or more databases of persistence layer 315 may be duplicated to enable the information in the databases to be accessed locally and via a network.

In some aspects, parts of system 300 (e.g., certain services or functions of particular services, such as the marketplace service 342) may be provided to users through one or more applications, including desktop and mobile versions.

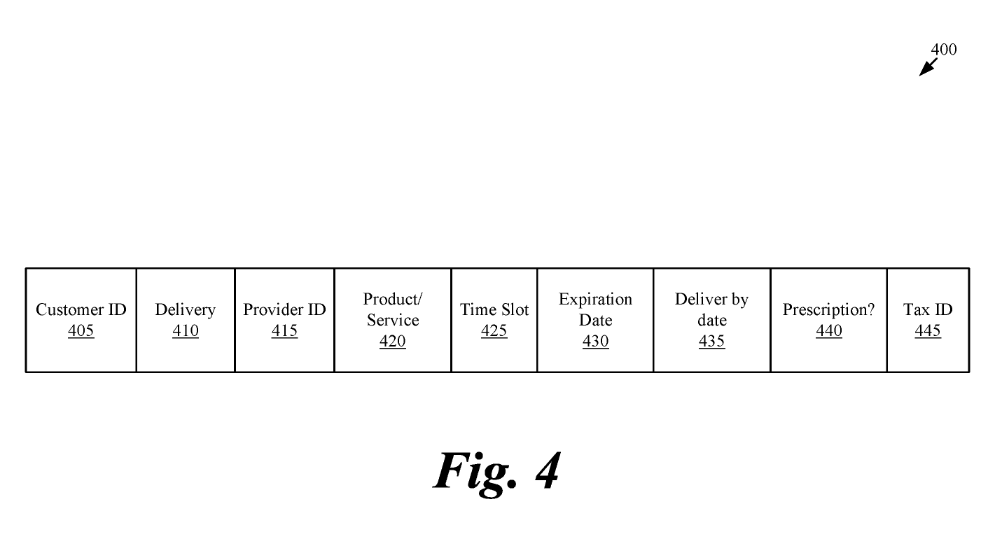

FIG. 4 illustrates an example data structure 400 the represents or defines a CDPR. In one example, the CDPR data structure or object includes a customer ID field 405, a delivery field 410, a provider and provider ID field (e.g., medical provider) 415, a product/service filed 420, a time/date slot filed 425, an expiration date 430, a delivery by date 435, a prescription requirement filed 440, and a tax ID 445. In some cases, one or more of the fields 405-445 may be optional. In some aspects, a CDPR unique ID may be included with data structure 400 or be derived from one or more field of data structure 400. The CDPR unique ID may uniquely identify a medical good or service associated with ownership. Ownership, as described herein is independent from delivery, such that ownership of a CDPR grants a transferable right to delivery of the medical good or service. In some aspects, this transferable right is also contingent upon one or more conditions, such as proof of a valid prescription. In some cases ownership of a CDPR may only provide this transferrable right. Each CDRP data structure 400 may be managed by the CDPR service 352, and stored/accessed via the customer database 364, the goods and services database 366, and/or the product listings database.

In some aspects, ownership of a CDPR may be indicated in the customer database 364. For example, when a customer purchases or otherwise obtains a CDPR, the CDPR unique ID may be associated with the particular customer in the customer database 364. When a medical good or service is first made available for transfer by system 300, identification of the good or service, and information thereof, may be stored in the product listing database 378. In some aspects, the medical good or service information will be stored in the goods and services database 366, where each particular instance of that medical good or service, with an associated redemption time, may be referenced and listed in the product listing database 378. In some cases, associating and listing may be performed by the marketplace service 342 and/or the CDPR service 352.

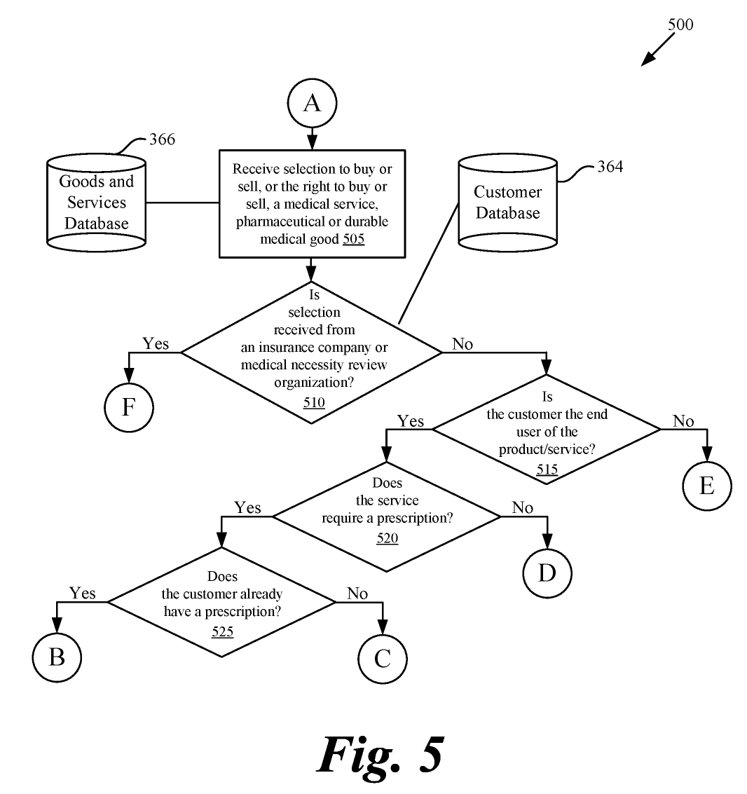

FIGS. 5-12 illustrate flow charts of an example process for transferring a contingently deliverable property, for example, that may be implemented by the contingently deliverable property right platform 300 described above in reference to FIG. 3 and/or that utilizes the CDPR 400 described in reference to FIG. 4. It should be appreciated that the following processes and sub-processes are only given by way of example, and that various modifications to the following processes and sub-processes are contemplated herein.

FIG. 5 illustrates a sub-process 500 for transacting a medical good or service, or example through system 300. In some cases, sub-process 500 may include requesting information and receiving one or more pieces of information through a UI provided by the marketplace service 342, and may include accessing the goods and services database 366 and the customer database 364.

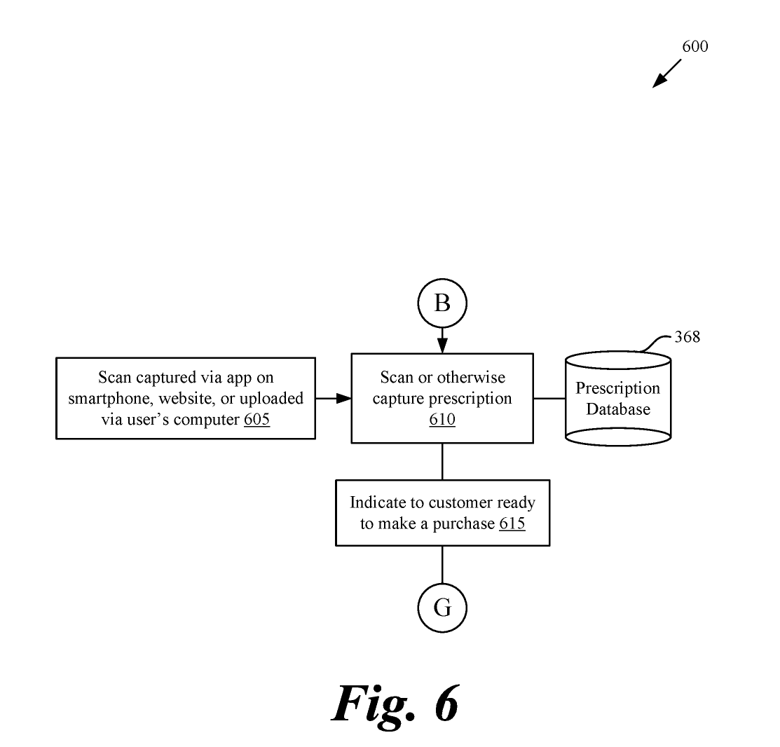

FIG. 6 illustrates a sub-process 600, for example, that may be performed if a customer already has a prescription for a medical good or service, as determined at operation 525 of sub-process 500. Sub-process 600 may be performed by the prescription verification service 354 and may include accessing the prescription database 366.

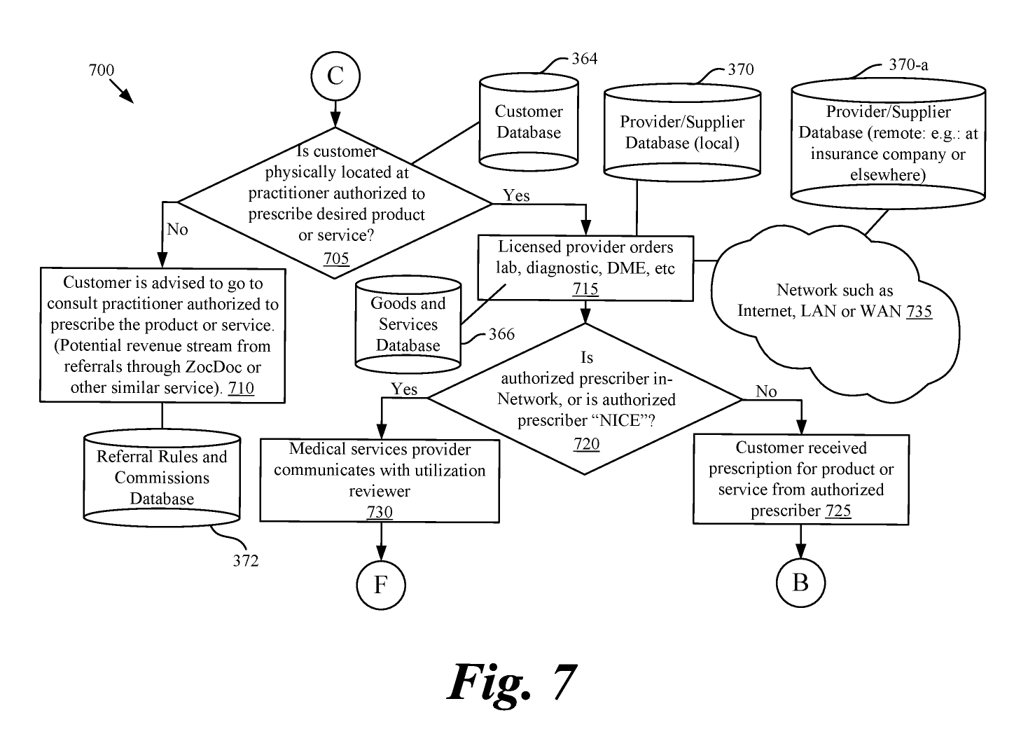

FIG. 7 illustrates a sub-process 700, for example, that may be performed if a customer does not have a prescription for a medical good or service, as determined at operation 525 of sub-process 500. Sub-process 700 may be performed at least in part by one or more of the medical service provider service 348, the CDPR service 352, the utilization review service 346, and/or the marketplace service 324, and may include accessing the customer database 364, the goods and services database 366, the provider/supplier database 370/remote provider/supplier database 370-a, and the referral rules and commissions database 372.

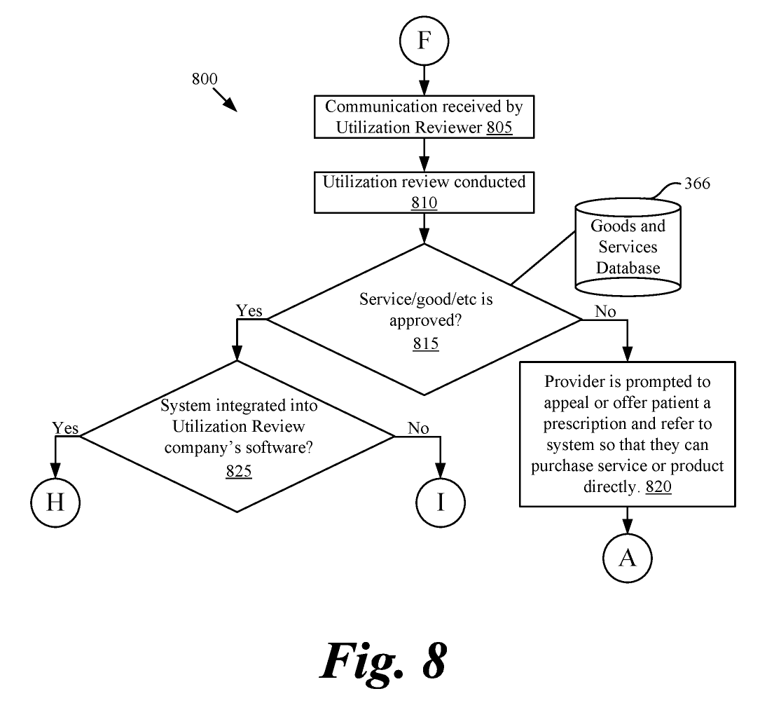

FIG. 8 illustrates a sub-process 800, for example, that may be performed if a customer is an insurance company or utilization review organization, as determined at operation 510 of sub-process 500. Sub-process 800 may be performed by the utilization review service 346, and may include accessing the goods and services database 366.

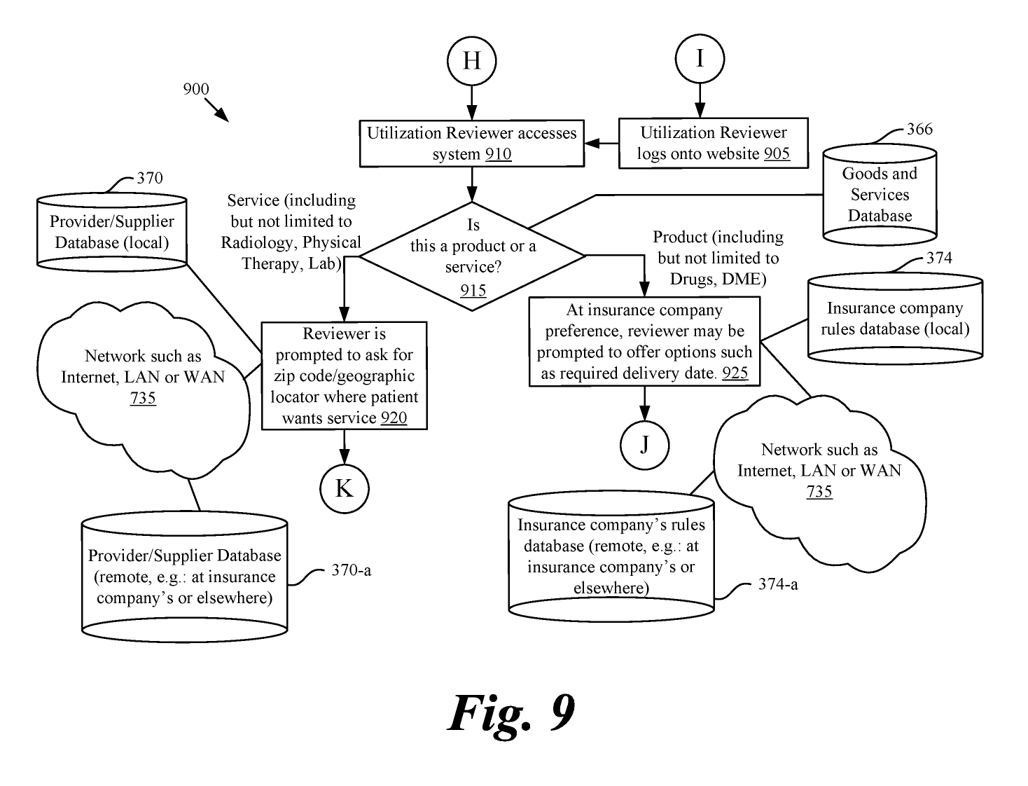

FIG. 9 illustrates a sub-process 900, for example, that may be performed after operations 730 or 725 of sub-process 700. Sub-process 900 may be performed by the utilization review service 346, and may include accessing the goods and services database 366, the provider/supplier database 370, and the insurance company rules database 374/remote insurance company rules database 374-a.

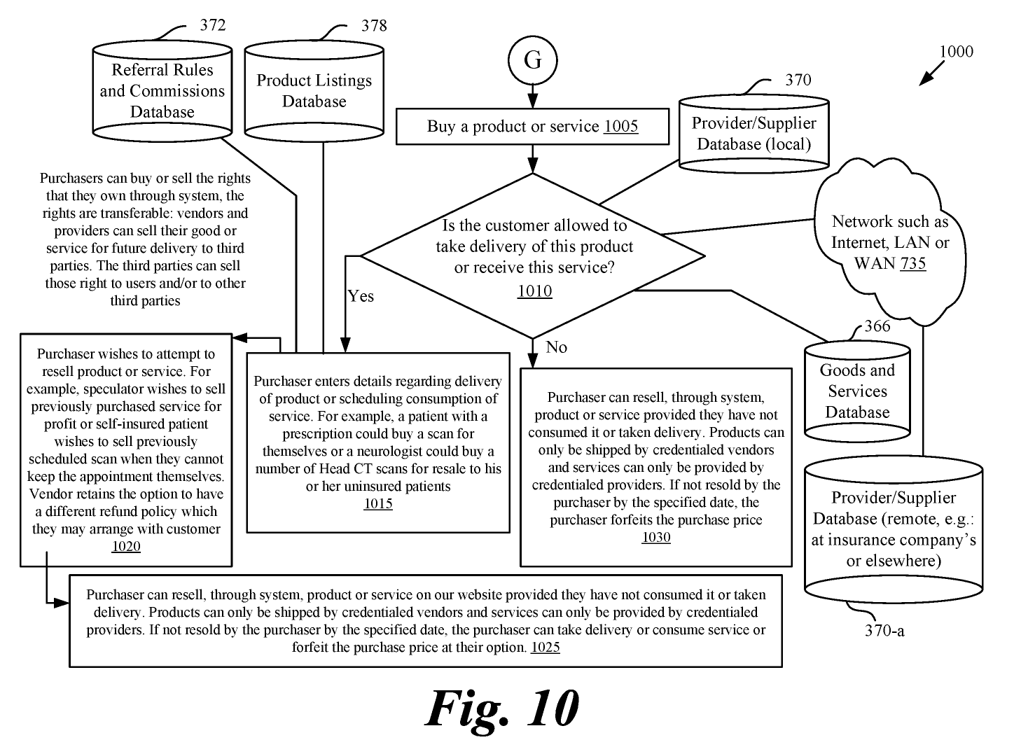

FIG. 10 illustrates a sub-process 1000, for example, that may be performed after operations 615 of sub-process 600. Sub-process 1000 may be performed by the marketplace service 342, and may include accessing the goods and services database 366, the provider/supplier database 370/remote provider/supplier database 370-a, the product listings database 378, and he referral rules and commissions database 372.

FIG. 11 illustrates a sub-process 1100, for example, that may be performed after operations 925 of sub-process 900. Sub-process 1100 may be performed by the marketplace service 342, and may include accessing the goods and services database 366, the provider/supplier database 370/remote provider/supplier database 370-a, the product listings database 378, and the referral rules and commissions database 372.

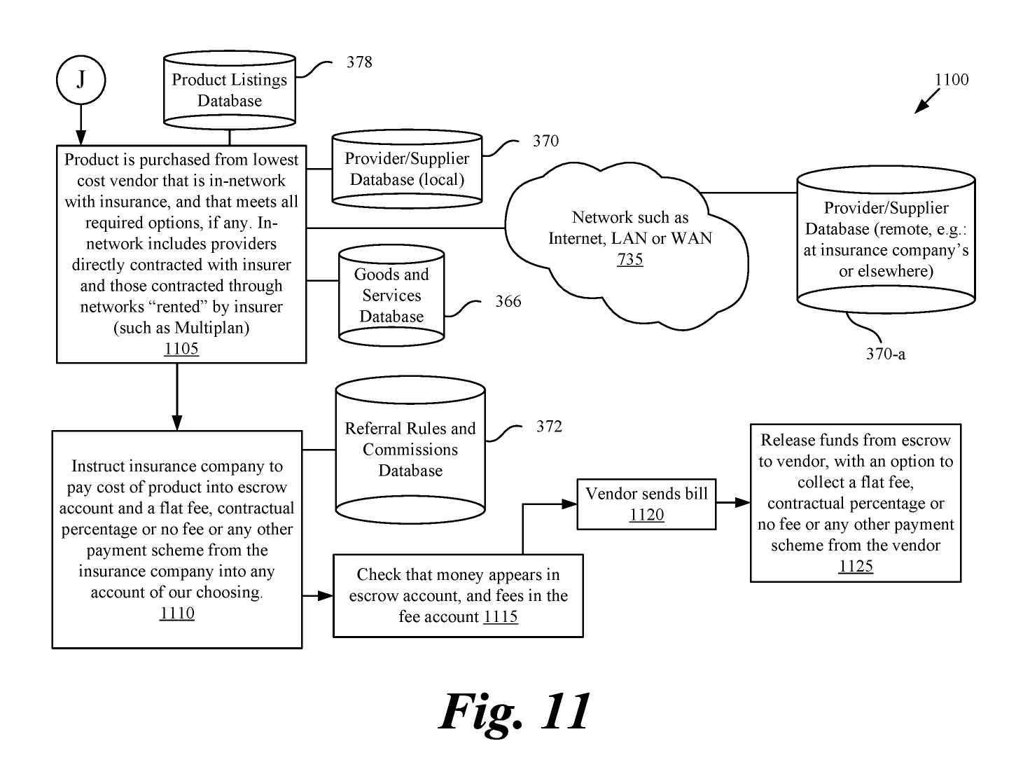

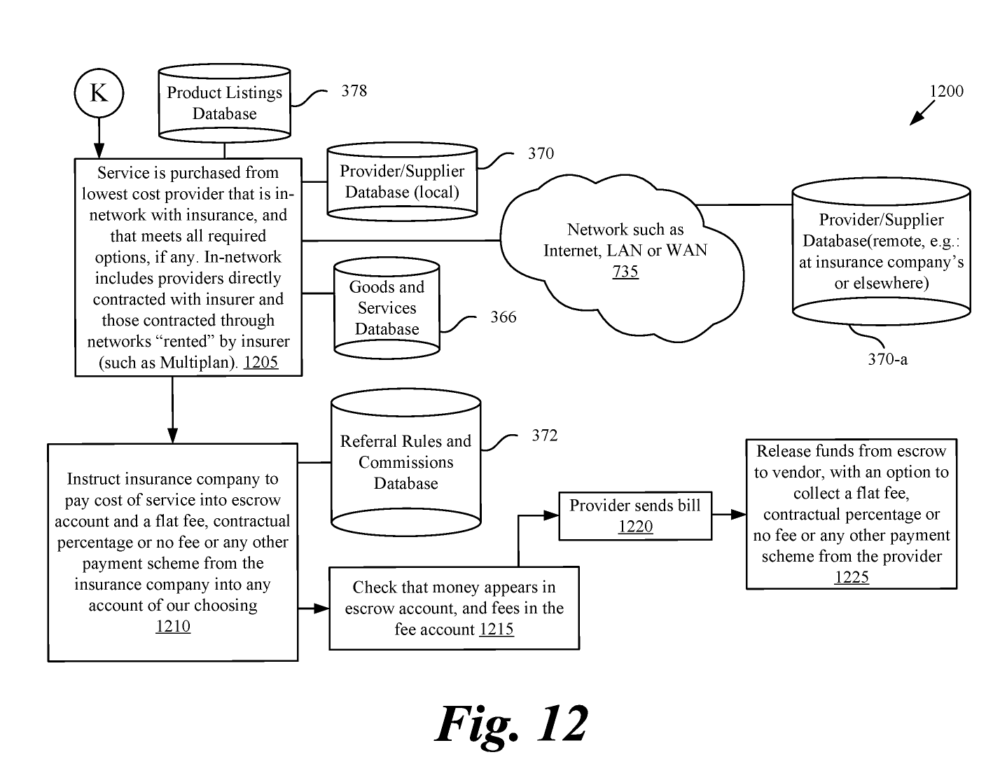

FIG. 12 illustrates a sub-process 1200, for example, that may be performed after operations 920 of sub-process 900. Sub-process 1200 may be performed by the marketplace service 342, and may include accessing the goods and services database 366, the provider/supplier database 370/remote provider/supplier database 370-a, the product listings database 378, and the referral rules and commissions database 372.

FIGS. 13-20 illustrate example user interfaces (UIs) that may be provided by CDPR platform 300 described in reference to FIG. 3. In some cases, UIs 1300-2000 may be provided by marketplace services 364 in conjunction with one or more databases from persistence layer 315.

FIG. 13 illustrates an example view 1300 of a UI, for example, that is provided by marketplace service 342, including options to search for a medical good or service to purchase.

FIG. 14 illustrates an example view 1400 of a UI, for example, that is provided by marketplace service 342, including options to purchase a CDPR for a medical good or service.

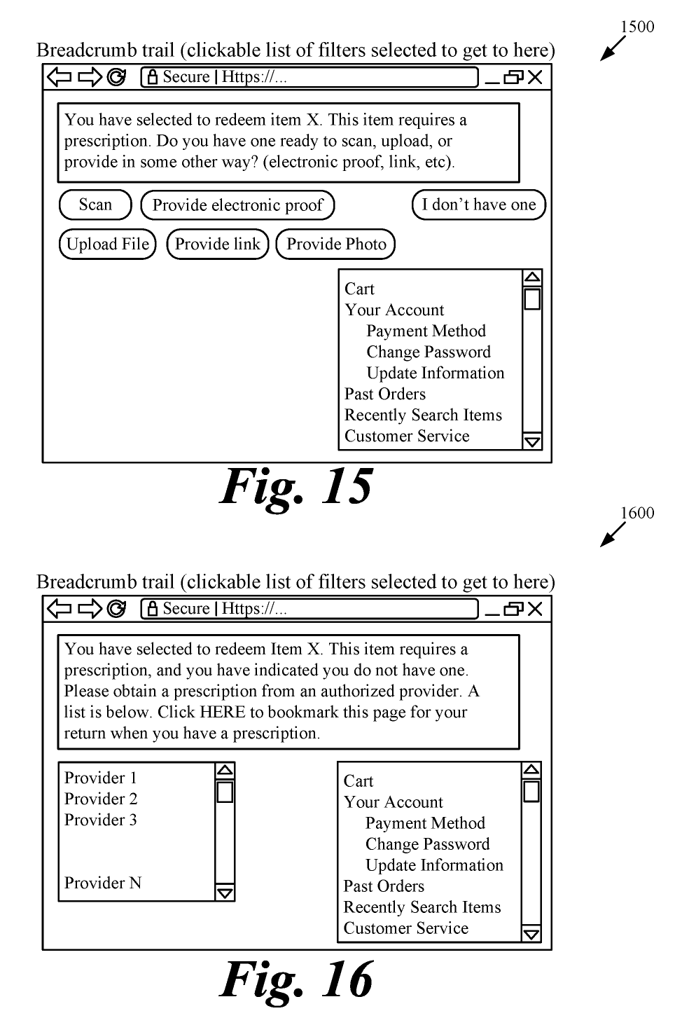

FIGS. 15 and 16 illustrates example views 1500 and 1600 of a UI, for example, that is provided by prescription verification service 354, marketplace service 342, and/or medical service provider service 348, including options and responses to check a prescription for redemption of a medical good or service.

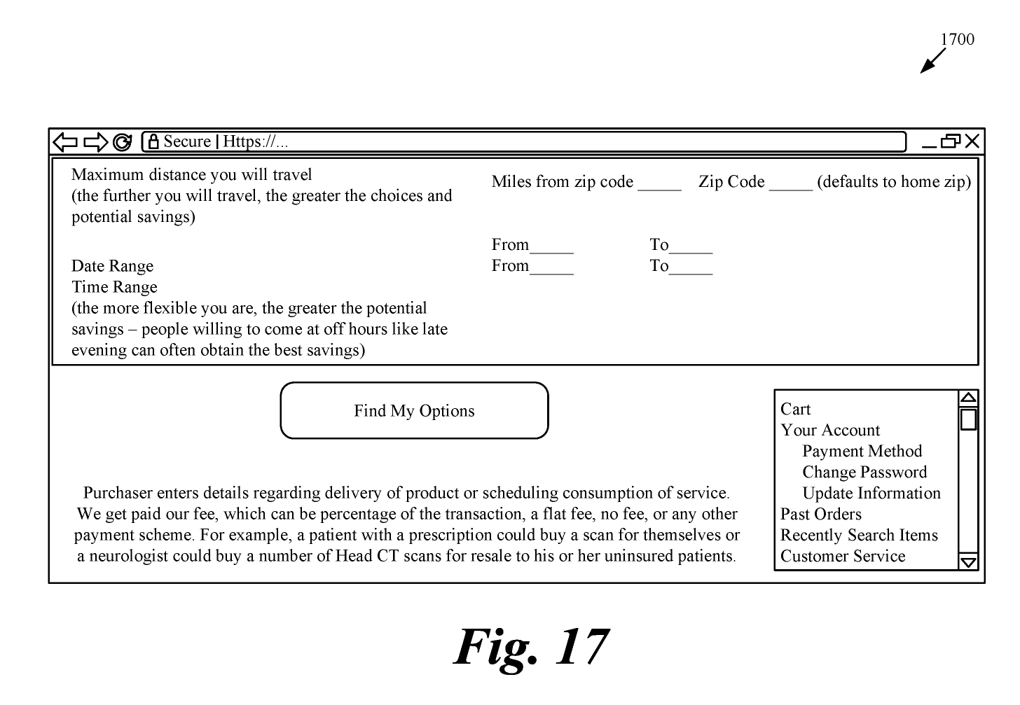

FIGS. 17, 18, and 19 illustrates example views 1700 1800, and 1900 of a UI, for example, that is provided by marketplace service 342, including options to search for and purchase a CDPR for a medical good or service.

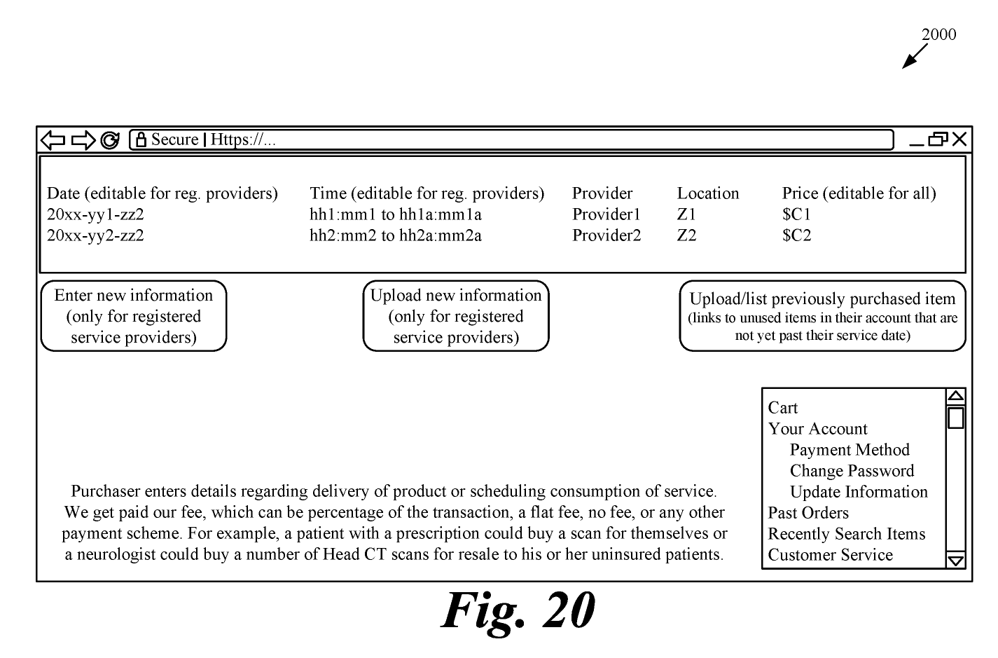

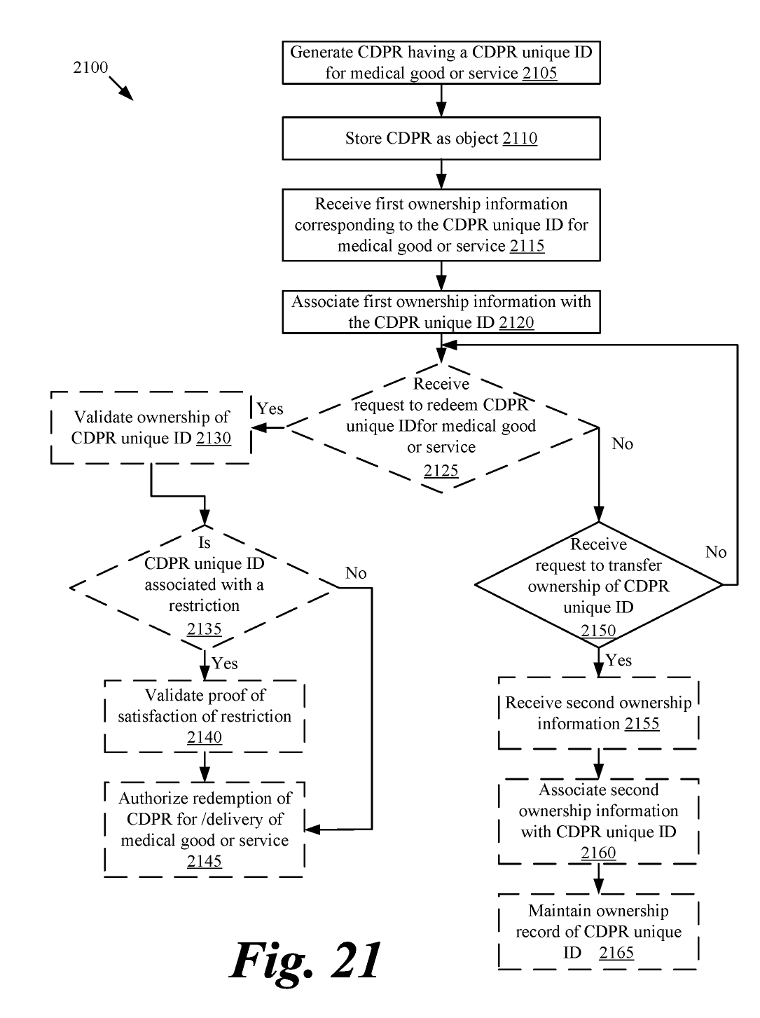

FIG. 20 illustrates an example view 2000 of a UI, for example, that is provided by marketplace service 342, including options to list a product or service in system 300.

It should be appreciated that example views of the UIs described above in relation to FIGS. 13-20 are only given by way of example. Other UIs featuring different configurations and different selection options are contemplated herein.

FIG. 21 illustrates an example process 2100 for generating, transferring, and/or redeeming a CDPR having a CDPR unique ID. Process 2100 may be performed by one or more services of service layer 310 of system 300, utilizing information from one or more databases from persistence layer 315 of system 300. Each operation indicated via dashed lines indicates an optional operation, such that process 2100 may be performed, in some aspects, without the optional operations.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A contingently deliverable property right (CDPR) computing system comprising:
a processor; and
a memory communicatively coupled to the processor, storing instructions that when executed by the processor, cause the computing system to perform the following operations:
generating a CDPR unique ID for a medical good or service made available by a medical provider and storing the CDPR unique ID and medical good or service information in an object in the memory;
receiving first ownership information corresponding to the medical good or service; and
associating the first ownership information with the CDPR unique ID, wherein the CDPR unique ID indicates a freely tradable right to take delivery of the medical good or service.

2. The system of claim 1, wherein the CDPR unique ID indicates only a freely tradable right to take delivery of the medical good or service.

3. The system of claim 1, wherein actual delivery of the medical good or service is contingent upon at least one condition.

4. The system of claim 3, wherein the at least one condition comprises a prescription requirement, wherein the instructions, when executed by the processor, further cause the system to perform the following operations:
requesting prescription information corresponding to the prescription requirement;
upon receiving the prescription information, verifying that the prescription information satisfies the prescription requirement; and
based on the verification, authorizing at least one of redemption, consumption, or delivery of the medical good or service.

5. The system of claim 3, wherein the instructions, when executed by the processor, further cause the system to perform the following operations:
receiving a request to redeem the medical good or service;
receiving ownership verification information;
comparing the ownership verification information with the CDPR unique ID;
requesting prescription information corresponding to the at least one condition;
upon receiving the prescription information, verifying that the prescription information satisfies the prescription requirement; and
based on the comparison and the verification, authorizing at least one of redemption, consumption, or delivery of the medical good or service.

6. The system of claim 1, wherein the instructions, when executed by the processor, further cause the system to perform the following operations:
receiving a request to redeem the medical good or service;
receiving ownership verification information;
comparing the ownership verification information with the CDPR unique ID; and
based on the comparison, authorizing redemption of the medical good or service.

7. The system of claim 1, wherein the instructions, when executed by the processor, further cause the system to perform the following operations:
receiving second ownership information corresponding to the medical good or service; and
associating the second ownership information with the CDPR unique ID and storing the second ownership information and the CDPR unique ID as the object in the memory.

8. The system of claim 7, wherein the instructions, when executed by the processor, further cause the system to perform the following operations:
maintaining a record of the first ownership information, wherein the record is associated with the CDPR unique ID.

9. The system of claim 1, wherein the instructions for receiving updated ownership information further comprise instructions for processing a transfer of ownership of the medical good or service.

10. The system of claim 1, wherein the instructions, when executed by the processor, further cause the system to perform the following operations:
providing at least a portion of the object to at least one of a utilization reviewing service or a user interface to indicate that the medical good or service is available.

11. The system of claim 1, wherein the instructions, when executed by the processor, further cause the system to perform the following operations:
displaying at least a portion of the object in at least one user interface, wherein the user interface comprises selections for transferring ownership of the medical good or service.

12. The system of claim 1, wherein the medical good or service is associated with a redemption time, wherein the instructions, when executed by the processor, further cause the system to perform the following operations:
automatically sending a reservation corresponding to the redemption time to a scheduling system associated with the medical provider.

13. A method for transferring a contingently deliverable property right (CDPR) associated with a medical good or service in a computerized system, the method comprising:
generating a CDPR unique ID for a medical good or service made available by a medical provider and storing the CDPR unique ID and medical good or service information in an object in the memory;
receiving first ownership information corresponding to the medical good or service; and
associating the first ownership information with the CDPR unique ID, wherein the CDPR unique ID indicates a freely tradable right to take delivery of the medical good or service.

14. The method of claim 13, wherein the CDPR unique ID indicates only a freely tradable right to take delivery of the medical good or service.

15. The method of claim 13, wherein actual delivery of the medical good or service is contingent upon at least one condition.

16. The method of claim 15, wherein the at least one condition comprises a prescription requirement, the method further comprising:
requesting prescription information corresponding to the prescription requirement;
upon receiving the prescription information, verifying that the prescription information satisfies the prescription requirement; and
based on the verification, authorizing at least one of redemption, consumption, or delivery of the medical good or service.

17. The system of claim 15, further comprising:
receiving a request to redeem the medical good or service;
receiving ownership verification information;
comparing the ownership verification information with the CDPR unique ID;
requesting prescription information corresponding to the at least one condition;
upon receiving the prescription information, verifying that the prescription information satisfies the prescription requirement; and
based on the comparison and the verification, authorizing at least one of redemption, consumption, or delivery of the medical good or service.

18. The method of claim 13, further comprising:
receiving a request to redeem the medical good or service;
receiving ownership verification information;
comparing the ownership verification information with the CDPR unique ID; and
based on the comparison, authorizing redemption of the medical good or service.

19. The method of claim 13, further comprising:
receiving second ownership information corresponding to the medical good or service;
associating the second ownership information with the CDPR unique ID and storing the second ownership information and the CDPR unique ID as the object in the memory; and
maintaining a record of the first ownership information, wherein the record is associated with the CDPR unique ID.

20. The method of claim 13, further comprising:
providing at least a portion of the object to at least one of a utilization reviewing service or a user interface to indicate that the medical good or service is available.
